(19) United States
(12) Patent Application Publication
(10) Pub. No.: US 2026/0110534 A1
(43) Pub. Date: Apr. 23, 2026

(54) INPECTION APPARATUS FOR UPPER SURFACE OF POGO PIN

(71) Applicant: ENSCAPE CO., LTD., Yongin-si (KR)

(72) Inventors: In Ho KA, Seongnam-si (KR); Ji Man Ryu, Suwon-si (KR); Seong Gi Kim, Asan-si (KR); Dong Hyun Jung, Hwaseong-si (KR); Sang Baek Kim, Seongnam-si (KR)

(21) Appl. No.: 19/330,034

(22) Filed: Sep. 16, 2025

(30) Foreign Application Priority Data
Oct. 17, 2024 (KR) 10-2024-0142231

(51) Int. Cl. G01B 11/26; H01R 13/24; H01R 101/00

(52) U.S. Cl. CPC G01B 11/26; H01R 13/2471; H01R 2101/00

(57) ABSTRACT

Disclosed is inspection apparatus for an upper surface of a pogo pin, including: a seating unit configured to allow an erected pogo pin to be seated thereon; a mirror provided above the seating unit and inclined at a predetermine angle around the pogo pin; and a camera module provided vertically above the seating unit, wherein the pogo pin includes a barrel and a plunger configured to allow at least a portion of a lower end to be inserted into the barrel, and the predetermined angle depends on the maximum angle between the plunger and the barrel during manufacturing.

### CROSS REFERENCE TO RELATED APPLICATION

Priority to Korean Patent Application No. 10-2024-0142231 filed on Oct. 17, 2024, the entire disclosure of which is incorporated by reference herein, is claimed.

### BACKGROUND OF THE INVENTION

### Field of the Invention

The disclosure relates to an inspection apparatus for an upper surface of a pogo pin and, more particularly, to an apparatus for inspecting the external appearance of a pogo pin from above.

This application is the result of “Scale-up technology commercialization program”(Development of a pogo pin's appearance inspection equipment based on a reconfigurable manufacturing system and verification for mass production by demand companies, Project No: P0023213) managed by Korea Institute for Advancement of Technology (KIAT).

### Description of the Related Art

With development of artificial intelligence (AI), Internet of things (IoT), big data, etc. the transition to a data economy is rapidly increasing a demand for semiconductors in various industrial fields such as autonomous vehicles, robots, 5G wireless communication, and mobile home appliances. In a semiconductor process, pogo pins are required as a key component for testing the performance and reliability of a semiconductor. In connection with the pogo pins, Korean Patent No. 1204273 has been disclosed.

The pogo pins are produced in various specifications to have a minimum diameter of about 0.15 mm and a minimum length of 1 mm. Till now, the appearance of the pogo pin has been inspected with the naked eyes using a microscope, and classification work has also been carried out manually, thereby resulting in a problem of lowering a production efficiency.

To solve the conventional problem, an apparatus for automatically inspecting the appearance of the pogo pin is needed, and an apparatus for aligning the posture of the pogo pin is also essentially needed.

The foregoing problem arises in not only the pogo pins but also small electronic components.

### Documents of Related Art

(Patent Document 1) Korean Patent No. 1204273 (published on November 23, 2012)

### SUMMARY OF THE INVENTION

To address problems of conventional pogo pin appearance inspection, an aspect of the disclosure is to provide an inspection apparatus for an upper surface of a pogo pin.

According to an embodiment of the disclosure, there is provided an inspection apparatus for an upper surface of a pogo pin, including: a seating unit configured to allow an erected pogo pin to be seated thereon; a mirror provided above the seating unit and inclined at a predetermine angle around the pogo pin; and a camera module provided vertically above the seating unit, wherein the pogo pin includes a barrel and a plunger configured to allow at least a portion of a lower end to be inserted into the barrel, and the predetermined angle depends on the maximum angle between the plunger and the barrel during manufacturing.

Meanwhile, the mirror may be configured to enable the camera module to capture a portion of the barrel obscured from view when the plunger is tilted relative to the barrel.

Further, the mirror may be provided in multiples arranged at a predetermined angle along a circumferential direction.

In addition, each of the mirrors may be configured in a plane form.

Meanwhile, the mirror may be configured of a curved surface, and configured in a ring form.

Meanwhile, the inspection apparatus may further include a camera module vertical position adjuster configured to adjust a vertical position of the camera module.

In addition, the inspection apparatus may further include a controller configured to control the camera module to capture an upper end of the barrel after capturing an upper end of the plunger.

Further, the inspection apparatus may further include an image processor configured to receive information related to an image from the camera module, and analyze the image to determine whether optical inference has occurred between the plunger and at least a portion of the upper surface of the barrel

Meanwhile, the controller may control the camera module to selectively acquire the image of the upper surface of the barrel reflected using the mirror.

Further, upon determining that the optical interference has occurred in the image of the upper surface of the barrel, the controller may control the vertical position adjuster so that the camera module can move closer to the barrel by a predetermined distance.

### BRIEF DESCRIPTION OF THE DRAWINGS

FIG. 1 is a conceptual diagram illustrating a pogo pin to be subjected to inspection according to the disclosure.

FIGS. 2A, 2B and 2C are diagrams illustrating the postures of a plunger when inspecting an upper surface of a pogo pin according to the disclosure.

FIG. 3 is a perspective view of an inspection apparatus for an upper surface of a pogo pin according to the disclosure.

FIG. 4 is a conceptual diagram illustrating a mirror module according to an embodiment of the disclosure.

FIG. 5 is a plan view showing a mirror module according to an embodiment of the disclosure.

FIG. 6 is a plan view showing an alternative example of a mirror module according to an embodiment of the disclosure.

FIG. 7 is a diagram showing the focuses of a camera according to an embodiment of the disclosure.

FIG. 8 is a conceptual diagram illustrating that a camera module acquires a first image according to the disclosure.

FIG. 9A shows the first image acquired according to the disclosure.

FIG. 9B is a conceptual diagram of a second image according to the disclosure.

FIG. 10 is a conceptual diagram illustrating that a third image is acquired according to the disclosure.

FIG. 11 shows the third image according to the disclosure.

### DETAILED DESCRIPTION OF THE INVENTION

Below, an inspection apparatus for an upper surface of a pogo pin according to an embodiment of the disclosure will be described in detail with reference to the accompanying drawings. In the following description, the names of components used may be referred to as other names in this art. However, these components may be considered as equivalent components in alternative embodiments if they are functionally similar or identical to each other. Further, the reference numerals of the components are merely given for the convenience of description. However, the components indicated by the reference numerals in the accompanying drawings are not limited by those shown therein. Likewise, if components are functionally similar or identical to each other even though they are partially modified in the drawings according to alternative embodiments, the components may be considered as the equivalent components. Further, if components are recognized as components that should be included at the level of those skilled in the art, descriptions thereof will be omitted.

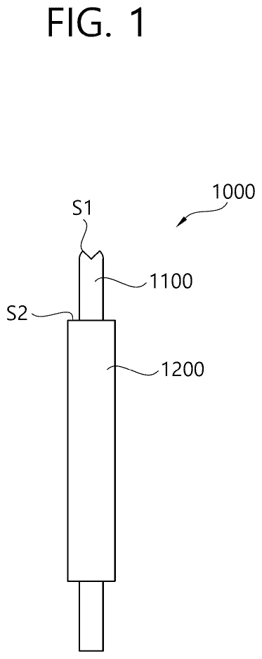

FIG. 1 is a conceptual diagram illustrating a pogo pin to be subjected to inspection according to the disclosure.

Referring to FIG. 1, a pogo pin 1000 to be subjected to inspection according to the disclosure may include a plunger 1100 and a barrel 1200. The plunger 1100 may have a lower portion configured to remain inserted into the barrel 1200. The plunger 1100 may have an upper end configured in a specific shape to facilitate electric contact and remain the contact. The upper end may have a stepped portion different in height, such as convexities and concavities.

The barrel 1200 may have an upper end crimped to prevent the pogo pin 1000 from coming off. Hereinafter, such a portion will be referred to as a ‘crimped portion.’ The crimped portion may extend a predetermined length toward the center of the barrel 1200 and prevent the plunger 1100 from coming out of the barrel 1200.

Meanwhile, the pogo pin 1000 may be configured in various shapes, but the configurations for its fundamental function are similar despite the variety of shapes. In other words, the insertion length of the plunger 1100 into the barrel 1200 may vary depending on an external force. Further, the pogo pin 1000 is configured such that the plunger 1100 does not come out of the barrel 1200 even when the external force is removed. The pogo pin 1000 configured for such a function may be subjected to the inspection according to the disclosure.

Although the term ‘upper surface’ of the pogo pin 1000 is used herein, this is merely for distinguishing between the ‘upper surface’ and the ‘lower surface’ for convenience of explanation. Thus, the upper surface of the pogo pin 1000 may refer to a portion of the pogo pin, which is observable from above in a vertical direction.

Meanwhile, a portion to be subjected to the inspection according to the disclosure may refer to a portion of the upper surface that is observable from above the pogo pin 1000. For example, the upper surface of the plunger 1100 and the upper surface of the barrel 1200 may be subjected to the inspection.

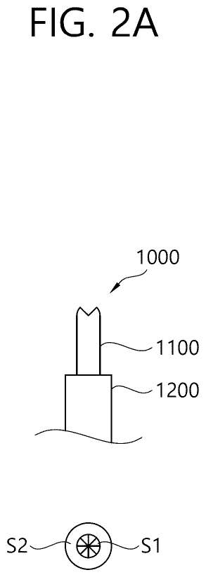

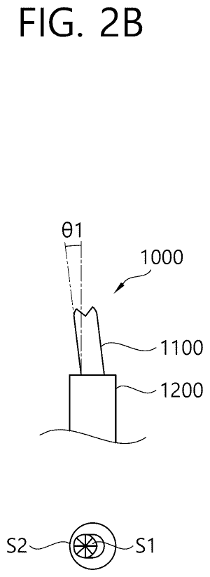

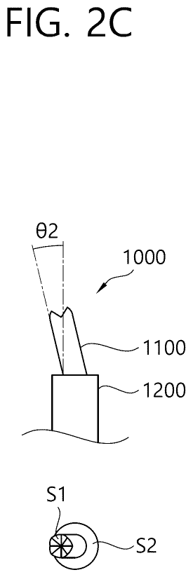

FIGS. 2A, 2B and 2C are diagrams illustrating the postures of the plunger 1000 when inspecting the upper surface of the pogo pin 1000 according to the disclosure. In this case, the upper parts in FIGS. 2A, 2B and 2C illustrate the postures of the pogo pin 1000 as viewed from the side. On the other hand, the lower parts illustrate the postures of the pogo pin 1000 as viewed from above when the pogo pin 100 is in the foregoing postures. Specifically, FIG. 2A illustrates the normal posture of the pogo pin 1000, in which the plunger 1100 is approximately perpendicular to the barrel 1200. In addition, FIG. 2B illustrates that, relative to FIG. 2A, the plunger 1100 is tilted to one side by an angle of θ1. Further, FIG. 2C illustrates that the plunger 1100 is tilted by an angle of θ2, which is larger than θ1.

Referring to FIGS. 2A, 2B and 2C, some of the pogo pins 1000 may be flexibly adjustable in posture. This may be achieved by adjusting the clearance between the plunger 1100 and the barrel 1200. With this structure, the posture of the plunger 1100 may vary within a specific range.

Referring to FIG. 2A, when the upper surface of the pogo pin 1000, in which the plunger 1100 and the barrel 1200 are aligned, is viewed from above, an upper surface S1 of the plunger 1100 and an upper surface S2 of the barrel 1200 are observable without interference.

On the other hand, in the state that the plunger 1100 is in a tilted posture as shown in FIG. 2B or 2C, the plunger 1100 interferes with the upper surface S2 of the barrel 1200 when viewed from above, thereby making accurate inspection difficult.

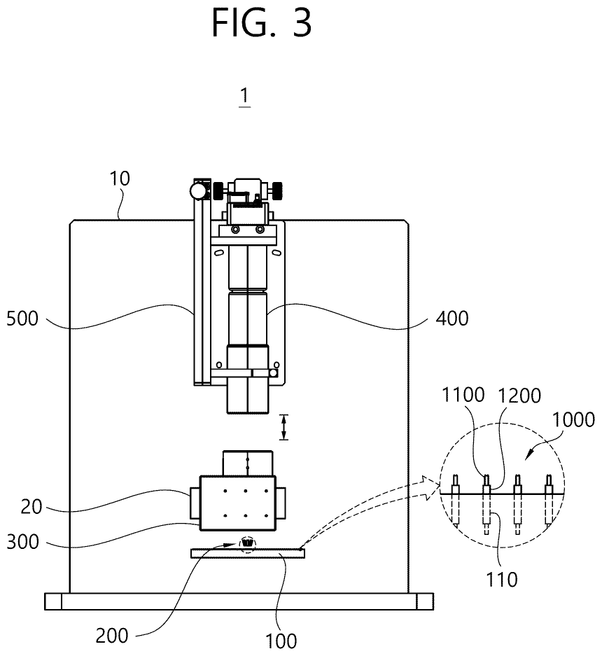

FIG. 3 is a perspective view of an inspection apparatus for an upper surface of a pogo pin according to the disclosure.

Referring to FIG. 3, the inspection apparatus 1 for the upper surface of the pogo pin according to the disclosure may accurately acquire the image of the upper surface of the pogo pin 1000 even though the plunger 1100 of the pogo pin 1000 is tilted as described above.

The inspection apparatus 1 for the upper surface of the pogo pin 1000 according to the disclosure may include a frame 10, a seating unit 100, a mirror module 200, a lighting module 300, a camera module 400, a vertical position adjuster 500, a controller, and an image processor.

The frame 10 serves as a base to which the components to be described later can be mounted. The frame 10 may extend to have a predetermined area in a vertical direction. Further, the frame 10 may be provided with components, such as the seating unit 100, in a horizontal direction. However, such configuration of the frame 10 is merely an example and may be modified in various forms capable of mounting the components of the disclosure.

The seating unit 100 is configured such that the pogo pin 1000 can be seated in an erect posture. The seating unit 100 is configured to transport the pogo pins 1000 being seated side by side. For example, the pogo pins 1000 may be transported to an inspection posture in sequence while being transported from the outside. The seating unit 100 may be provided with a plurality of seating grooves 110. The pogo pin 1000 may be loaded or inserted into each of the seating grooves 110 in an uprightly erect state. In this case, the seating groove 110 may be formed to a depth such that the upper surface of the barrel 1200 of the pogo pin 1000 can be positioned higher than the upper surface of the seating unit 100.

To this end, a movement unit (not shown) for the seating unit 100 may be provided.

The inspection apparatus 1 for the upper surface of the pogo pin 1000 may inspect the pogo pins 1000 in a first-in, first-out manner. Alternatively, the plurality of pogo pins 1000 may be loaded onto the seating unit 100 at once, and the seating unit 100 may be moved to inspect the pogo pins 1000 in sequence.

The mirror module 200 is configured such that the upper surface of the barrel 120 to be captured even when the plunger 1100 interferes with the upper surface of the barrel 1200. When the plunger 1100 is tilted and interferes with a portion of the upper surface of the barrel 1200, it is difficult for the camera module 400 to acquire an accurate image. In this case, by using the mirror module 200, an image of the upper surface of the barrel 1200 is acquired while avoiding the interference from the plunger 1100.

Meanwhile, the mirror module 200 may be mounted to the frame 10 by a mirror module mounting unit (not shown). The mirror module mounting unit may be implemented by various conventionally known mounting means.

The lighting module 300 is configured to irradiate light to the upper end of the pogo pin 1000. The lighting module 300 may be configured to irradiate light coaxially with the camera module 400 (to be described later). The lighting module 300 may include a coaxial lighting unit and a semi-reflective mirror.

The lighting module 300 may be mounted to the frame 10 by a lighting module mounting unit 20. The lighting module mounting unit 20 may be formed as a shelf-shaped member that mounts the lighting module 300 to the frame 10. In this case, the mirror module mounting unit (not shown) may also be formed similarly to the lighting module mounting unit 20.

The camera module 400 for capturing an image is oriented toward an inspection position. The camera module 400 may be provided with a focus-adjustable configuration. In addition, a polymer lens may be provided for fast focusing adjustment. The camera module 400 is configured to capture the image of the pogo pin 1000 seated at the inspection position from vertically above.

The camera module 400 may be provided above the lighting module 300. The camera module 400 is configured to acquire the image of the upper surface of the pogo pin 1000 while the lighting module 300 irradiates light coaxially with the camera module 400.

The vertical position adjuster 500 is configured to adjust the vertical position of the camera module 400. The vertical position adjuster 500 may operate in response to a focal distance varying depending on whether the camera directly captures the pogo pin 1000 or captures the image of the pogo pin 1000 reflected in the mirror. For example, the vertical position adjuster 500 may adjust the height of the camera module 400 to a first height when the camera directly captures the pogo pin 1000, and to a second height lower than the first height when the camera captures the pogo pin 1000 reflected in the mirror.

The image processor is configured to determine, based on the acquired image, whether the image acquisition using the mirror module 200 is necessary. The image processor may determine that the posture of the plunger 1100 is tilted and the upper surface of the barrel 1200 is not fully visible in the image captured from vertically above, and transmit a determination result to the controller. Further, the image processor determines which of the images captured using the mirror module 200 is to be used. The image processor may determine a defect in the appearance of the pogo pin 1000 based on the plurality of finally acquired images.

The controller is configured to control the components such as the camera module 400, the lighting module 300, the seating unit 100, and the vertical position adjuster 500. In particular, the controller may receive a signal from the image processor so as to adjust the vertical position of the camera module 400.

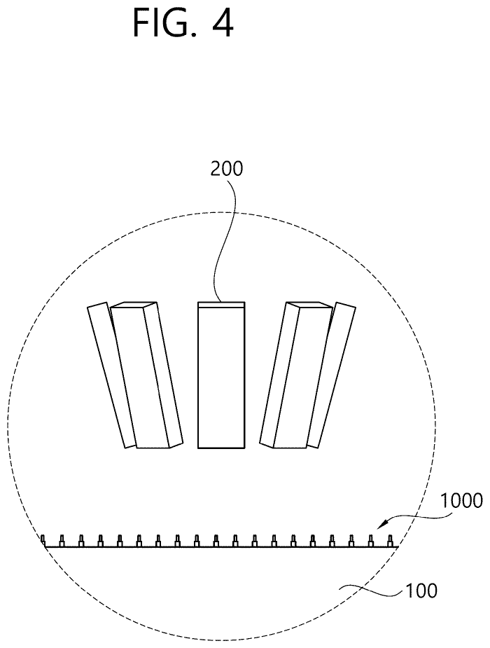

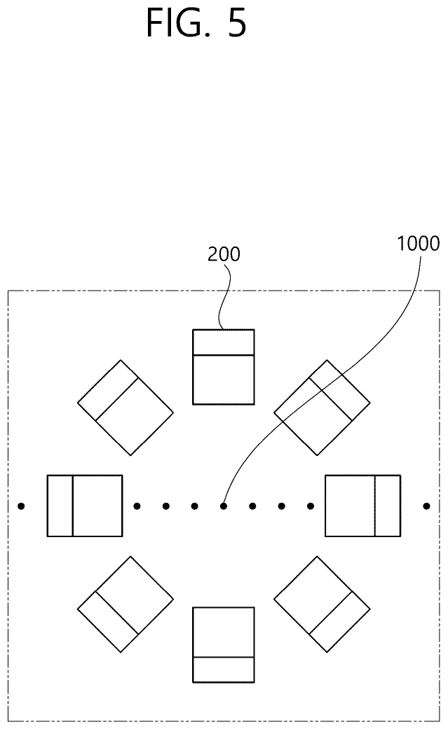

FIG. 4 is a conceptual diagram illustrating the mirror module 200 according to an embodiment of the disclosure, and FIG. 5 is a plan view showing the mirror module 200 according to an embodiment of the disclosure.

Referring to FIGS. 4 and 5, the mirror module 200 may be provided at a predetermined distance vertically from the upper end of the pogo pin 1000. The height of the mirror module 200 based on the distance may vary depending on a distance between the camera module 400 and the pogo pin 1000, the camera's field of view, and the position of the lighting module.

The mirror module 200 may be provided above the pogo pin 1000 seated at the inspection position. The mirror module 200 may include a plurality of mirrors arranged along a circumferential direction with respect to a central axis. For example, each mirror may be configured in a plane form.

The mirror module 200 may include, for example, eight mirrors arranged at 45-degree intervals along the circumferential direction.

The camera module 400 may acquire the image reflected from at least one mirror of the mirror module 200. The plunger 1100 may be tilted at random angles and in random directions. In this case, an image of the upper surface of the barrel 1200 obscured by the plunger 1100 may be reflected in at least one of the mirrors arranged in various directions, thereby enabling the image acquisition of the upper surface of the obscured barrel 1200.

In this embodiment, each mirror may have an area significantly larger than that of the pogo pin 1000 so as to accurately acquire the image of the upper surface of the barrel 1200.

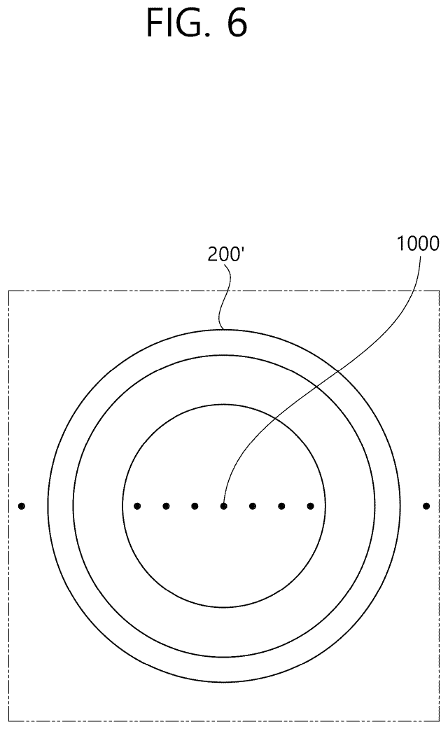

FIG. 6 is a plan view showing an alternative example of the mirror module 200 according to an embodiment of the disclosure.

Referring to FIG. 6, a mirror module 200′ may be configured in a curved form. In this case, the mirror module 200′ may be configured in a ring form inclined at an angle to face upward.

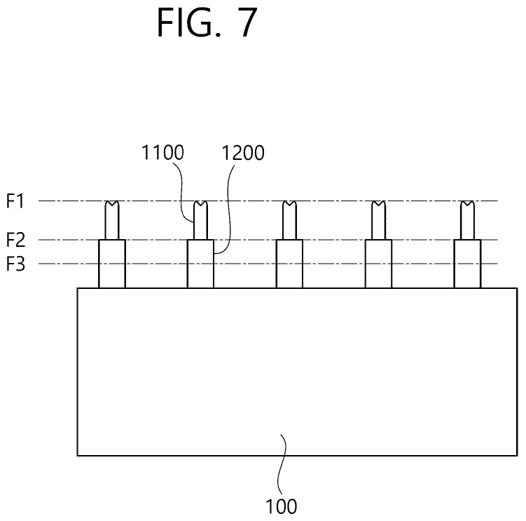

FIG. 7 is a diagram showing the focuses of a camera according to an embodiment of the disclosure.

Referring to FIG. 7, the camera module 400 according to the disclosure may be configured to acquire the images by focusing on at least three vertical positions.

A first focus F1 may be the height of the upper end of the plunger 1100 on the seating unit 100. A second focus F2 may be the height of the upper surface of the barrel 1200 on the seating unit 100. To adjust the focus between the first focus F1 and the second focus F2, a lens kit of the camera module 400 may be used.

Meanwhile, a third focus F3 may be farther than the second focus F2 in consideration of a reflection path of the mirror. By lowering the height of the camera module 400 using the vertical position adjuster 500, the camera module 400 may be brought into focus at the third focus F3. Meanwhile, when the inspection at the third focus F3 is completed, the vertical position adjuster 500 may raise the camera module 400 to its initial posture.

Alternatively, the camera module according to the disclosure may be configured to adjust its focus between the first focus F1 and the third focus F3.

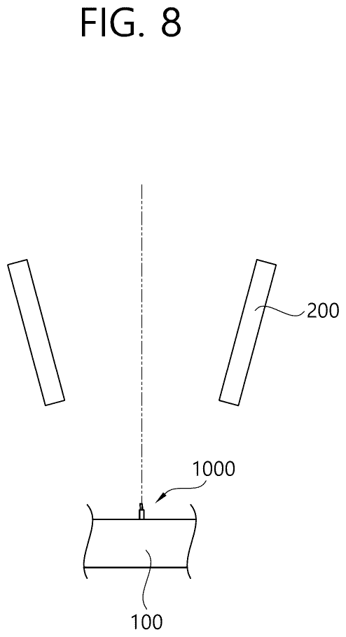

FIG. 8 is a conceptual diagram illustrating that the camera module 400 acquires a first image according to the disclosure.

Referring to FIG. 8, the image of the upper surface of the pogo pin 1000 is acquired while the lighting module 300 operates to irradiate light coaxially with the optical axis of the camera module 400. In this case, the image acquired using the mirror is not used even through it is acquired.

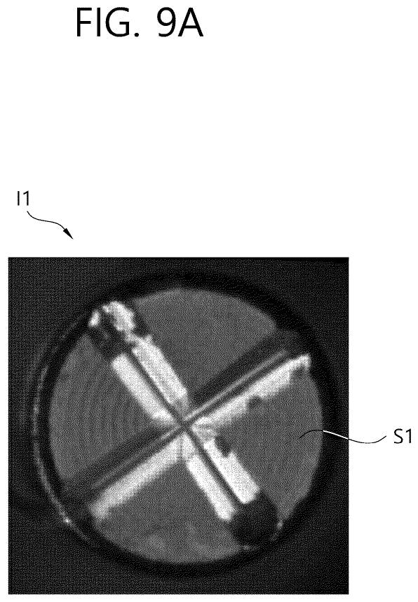

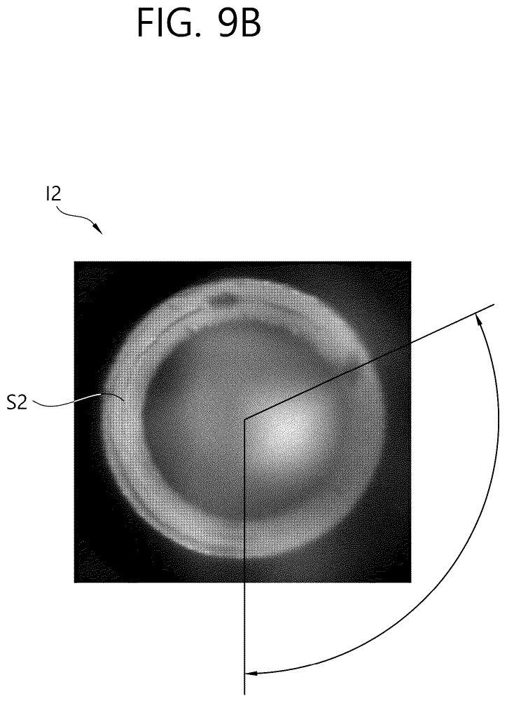

FIG. 9A shows the first image acquired according to the disclosure, and FIG. 9B is a conceptual diagram of a second image according to the disclosure.

Referring to FIG. 9A, the camera module 400 according to the disclosure may be first brought into focus at the first focus F1 to acquire a first image I1 in which the upper surface S1 of the plunger 1100 is shown.

Referring to FIG. 9B, the camera module 400 is then brought into focus at the second focus F2 to acquire a second image I2 in which the upper surface S2 of the barrel 1200 is shown. However, the first image I1 and the second image I2 may be acquired regardless of order.

In this case, if the plunger 1100 is tilted, the plunger 1100 may cause blocking and/or interference. Thus, the image of the upper surface S2 of the barrel 1200 is not accurately acquired in an interference area I. Meanwhile, the second image I2 captured at the second focus F2 is not accurately acquired because the plunger 1100 is out of focus.

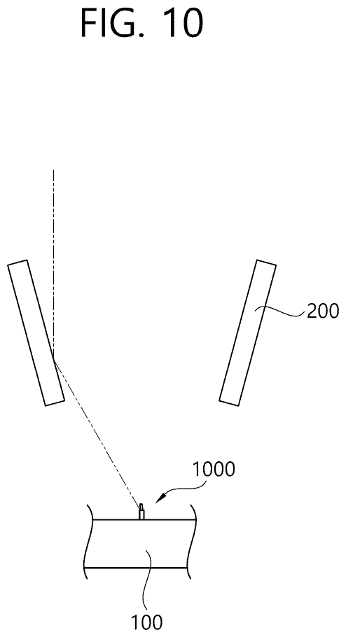

FIG. 10 is a conceptual diagram illustrating that a third image is acquired according to the disclosure.

Referring to FIG. 10, when the image processor determines that the second image I2 for the upper surface S2 of the barrel 1200 is not accurately acquired, the inspection apparatus for the upper surface of the pogo pin 1000 according to the disclosure extracts information about an inaccurate area and acquires a mirror reflection image for that area.

The controller operates the vertical position adjuster 500 to bring the camera module 400 into focus at the upper surface of the barrel 1200 along a reflection path of the mirror module 200. Then, the controller operates the camera module 400 to acquire the image of the upper surface S2 of the barrel reflected by the mirror. In this case, the upper surface S2 of the barrel reflected by multiple mirrors may be shown together in the acquired image, and the image processor may preferentially get an image corresponding to an area that is not accurately acquired at the second focus F2.

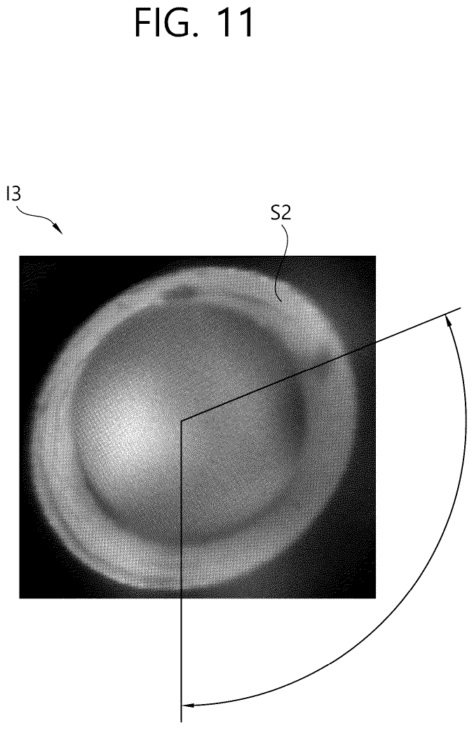

FIG. 11 shows the third image according to the disclosure.

Referring to FIG. 11, a third image I3 may be acquired, for example, in a state where the optical axis of the camera module 400 is aligned with the central axis of the tilted plunger 1100. In this case, the image of the upper surface S2 of the barrel 1200, in which the interference with the plunger 1100 is minimized, may be acquired using the mirror. Meanwhile, the image of the interference area I shown in FIG. 9B is accurately identified, and thus accurate inspection can be performed regardless of the postures of the plunger 1100.

As described above, the inspection apparatus for the upper surface of the pogo pin 1000 according to an embodiment of the disclosure can acquire an accurate appearance image of the tilted plunger 1100 during a manufacturing process, thereby dramatically improving inspection reliability.

In addition, the inspection apparatus for the upper surface of the pogo pin 1000 according to an embodiment of the disclosure can acquire an accurate image without changing the posture of the pogo pin 1000, thereby improving inspecting speed.

The inspection apparatus for the upper surface of the pogo pin according to the disclosure can quickly and accurately inspect the upper surface of the pogo pin despite the posture defects of the plunger of the pogo pin, thereby improving inspection accuracy, reliability, and inspection efficiency.

### REFERENCE NUMERALS

100: seating unit
200: mirror module
400: camera module
1000: pogo pin
S1: upper surface of plunger
S2: upper surface of barrel

What is claimed is:

1. An inspection apparatus for an upper surface of a pogo pin, comprising:
a seating unit configured to allow an erected pogo pin to be seated thereon;
a mirror provided above the seating unit and inclined at a predetermine angle around the pogo pin; and
a camera module provided vertically above the seating unit,
wherein the pogo pin comprises a barrel and a plunger configured to allow at least a portion of a lower end to be inserted into the barrel, and
the predetermined angle depends on the maximum angle between the plunger and the barrel during manufacturing.

2. The inspection apparatus of claim 1, wherein the mirror is configured to enable the camera module to capture a portion of the barrel obscured from view when the plunger is tilted relative to the barrel.

3. The inspection apparatus of claim 2, wherein the mirror is provided in multiples arranged at a predetermined angle along a circumferential direction.

4. The inspection apparatus of claim 3, wherein each of the mirrors is configured in a plane form.

5. The inspection apparatus of claim 2, wherein the mirror is configured of a curved surface, and configured in a ring form.

6. The inspection apparatus of claim 2, further comprising a camera module vertical position adjuster configured to adjust a vertical position of the camera module.

7. The inspection apparatus of claim 6, further comprising a controller configured to control the camera module to capture an upper end of the barrel after capturing an upper end of the plunger.

8. The inspection apparatus of claim 7, further comprising an image processor configured to receive information related to an image from the camera module, and analyze the image to determine whether optical inference has occurred between the plunger and at least a portion of the upper surface of the barrel.

9. The inspection apparatus of claim 8, wherein the controller controls the camera module to selectively acquire the image of the upper surface of the barrel reflected using the mirror.

10. The inspection apparatus of claim 9, wherein, upon determining that the optical interference has occurred in the image of the upper surface of the barrel, the controller controls the vertical position adjuster so that the camera module can move closer to the barrel by a predetermined distance.
